(19) United States
(12) Patent Application Publication
(10) Pub. No.: US 2016/0102649 A1
(43) Pub. Date: Apr. 14, 2016

(54) GLOW PLUG

(71) Applicant: NGK SPARK PLUG CO., LTD., Nagoya-shi (JP)

(72) Inventor: Takayuki OHTANI, Iwakura-shi (JP)

(73) Assignee: NGK SPARK PLUG CO., LTD., Nagoya-shi (JP)

(21) Appl. No.: 14/870,539

(22) Filed: Sep. 30, 2015

(30) Foreign Application Priority Data
Oct. 9, 2014 (JP) 2014-207747

(51) Int. Cl. F02P 19/02; F23Q 7/00

(52) U.S. Cl. CPC F02P 19/028; F23Q 7/001; F23Q 2007/002

(57) ABSTRACT

A glow plug having a heater portion configured to generate heat by being energized; a center wire having electrical conductivity, connected to the heater portion; a feed terminal having electrical conductivity; a spring member having electrical conductivity and configured to elastically deform such that the heater portion and the center wire are movable along the axial direction relative to the feed terminal, the spring member connecting the center wire and the feed terminal; a wall surface defining a region for accommodating the spring member; and an elastic portion having electrical insulation property and lower elasticity than that of the spring member, the elastic portion covering at least a part of the spring member while being in contact with the wall surface.

### RELATED APPLICATIONS

This application claims the benefit of Japanese Patent Application No. 2014-207747, filed Oct. 9, 2014.

### FIELD OF THE INVENTION

The present invention relates to a glow plug.

### BACKGROUND OF THE INVENTION

There has been known a glow plug that includes a heater portion having a rod shape extending in the axial direction thereof, the glow plug configured to be able to detect the pressure in a combustion chamber based on displacement of the heater portion in the axial direction. The heater portion of the glow plug is supplied with electric power through a center wire which is connected to the heater portion so as to be electrically conductive therewith.

When the center wire vibrates due to displacement of the center wire in a radial direction orthogonal to the axial direction, the vibration of the center wire propagates to a pressure detection portion. When the center wire comes into contact with another member, displacement of the heater portion in the axial direction is hindered. Thus, displacement of the center wire in the radial direction can cause increase of measurement errors of the pressure detected based on the displacement of the heater portion. US Patent Application Publication No. 2005/0061063 discloses a glow plug in which, in order to suppress displacement of the center wire in the radial direction, the center wire is retained via an O-ring.

The glow plug of US Patent Application Publication No. 2005/0061063 has a problem that due to dimension errors in members such as the center wire and the O-ring, displacement of the center wire in the axial direction tends to be hindered. When displacement of the center wire in the axial direction is hindered, displacement of the heater portion in the axial direction is also hindered. Thus, measurement errors of the pressure detected based on the displacement of the heater portion will increase. In addition, when the center wire is insufficiently retained due to dimension errors in members such as the center wire and the O-ring, measurement errors of the pressure will increase due to vibration of the center wire.

### SUMMARY OF THE INVENTION

The present invention has been made in order to solve the above problem, and can be realized in the following modes.

(1) In accordance with a first aspect of the present invention, there is provided a glow plug that includes: a heater portion having a rod shape extending from a front side toward a rear side in an axial direction, the heater portion configured to generate heat by being energized; a center wire having electrical conductivity, extending from the heater portion toward the rear side, and being connected to the heater portion so as to be electrically conductive therewith; a feed terminal having electrical conductivity, being positioned on the rear side relative to the center wire, and configured to be supplied with electric power for the heater portion; a spring member having electrical conductivity and configured to elastically deform such that the heater portion and the center wire are movable along the axial direction relative to the feed terminal, the spring member connecting the center wire and the feed terminal such that the center wire and the feed terminal are electrically conductive with each other; a wall surface defining a region for accommodating the spring member from the front side toward the rear side; and an elastic portion having electrical insulation property and lower elasticity than that of the spring member, the elastic portion covering at least a part of the spring member while being in contact with the wall surface. According to this mode, while allowing displacement of the center wire in the axial direction by means of the spring member, it is possible to suppress displacement of the center wire in a radial direction orthogonal to the axial direction, by means of the elastic portion via the spring member. Therefore, it is possible to prevent measurement errors of the pressure detected based on the displacement of the heater portion.

(2) In accordance with a second aspect of the present invention, there is provided a glow plug as described above, wherein the spring member may include a welded portion welded to the center wire, and the elastic portion may be filled between the wall surface and at least the welded portion of the spring member. According to this mode, displacement of the center wire in a radial direction orthogonal to the axial direction can be directly suppressed by means of the elastic portion. Therefore, the displacement of the center wire in the radial direction orthogonal to the axial direction can be further suppressed.

(3) In accordance with a third aspect of the present invention, there is provided a glow plug as described above, wherein the elastic portion may be in a paste form. According to this mode, the elastic portion can be easily realized.

(4) In accordance with a fourth aspect of the present invention, there is provided a glow plug as described above, wherein the elastic portion may be a solid having rubber elasticity. According to this mode, the elastic portion can be easily realized.

The present invention can be realized in various modes other than a glow plug. For example, the present invention can be realized in a mode such as a component of the glow plug, or a method for manufacturing the glow plug.

### BRIEF DESCRIPTION OF THE DRAWINGS

FIG. 1 is a cross-sectional view showing a glow plug.

FIG. 2 is an enlarged cross-sectional view of a part of the front side of the glow plug.

FIG. 3 is an enlarged cross-sectional view of a part of the rear side of the glow plug.

FIG. 4 is an enlarged cross-sectional view of a part of the rear side of a glow plug according to a second embodiment.

FIG. 5 is an enlarged cross-sectional view of a part of the rear side of a glow plug according to a third embodiment.

### DETAILED DESCRIPTION OF THE PREFERRED EMBODIMENTS

### A. First Embodiment

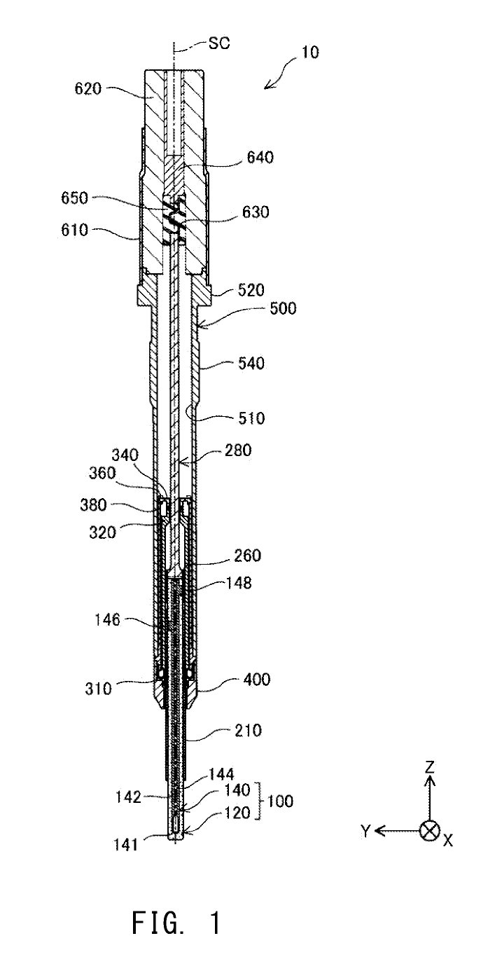

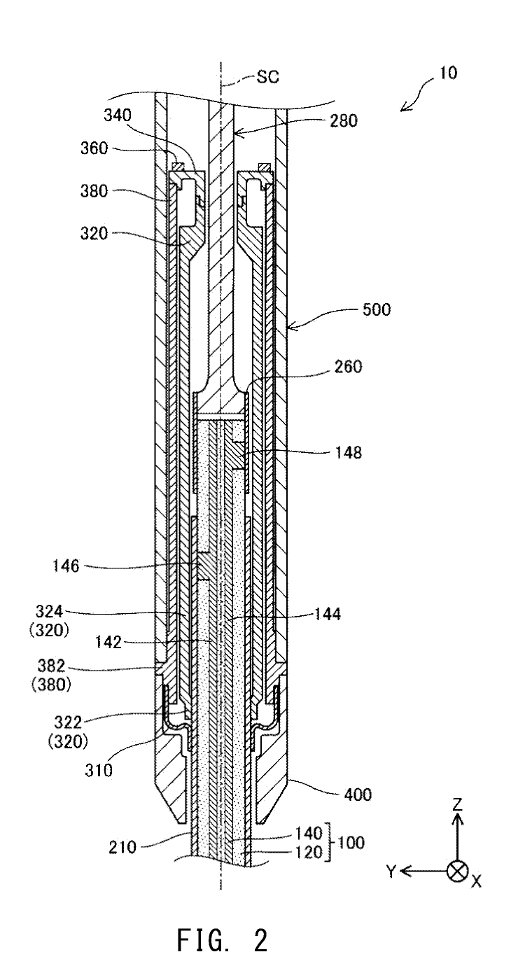

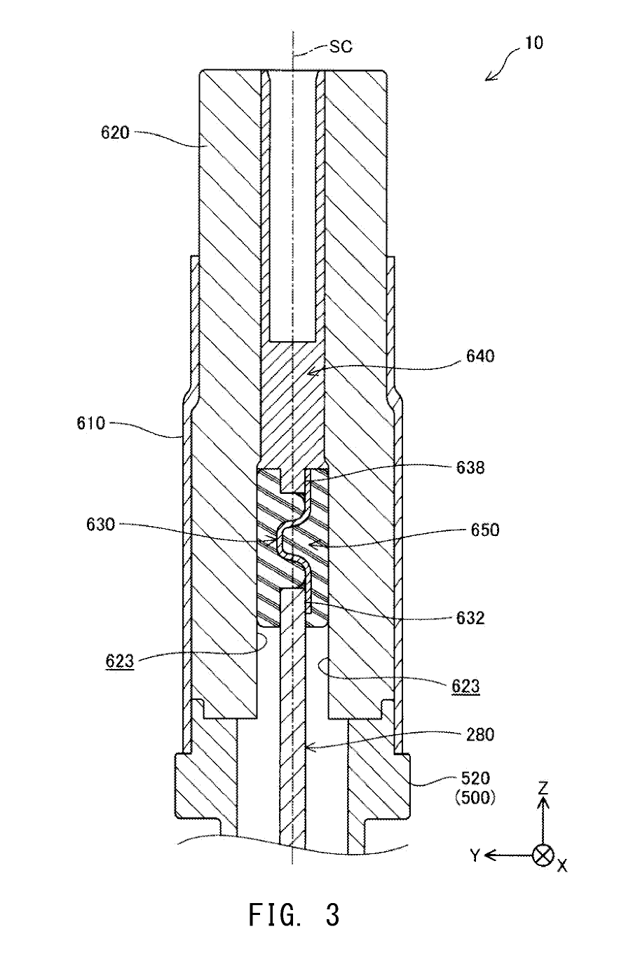

FIG. 1 is a cross-sectional view showing a glow plug 10. In the description of the present embodiment, with respect to the glow plug 10, the lower side in the sheet of FIG. 1 will be referred to as “front side”, and the upper side in the sheet of FIG. 1 will be referred to as “rear side”. FIG. 2 is an enlarged cross-sectional view of a part of the front side of the glow plug 10. FIG. 3 is an enlarged cross-sectional view of a part of the rear side of the glow plug 10.

FIG. 1 shows XYZ axes. The XYZ axes in FIG. 1 are an X axis, a Y axis, and a Z axis as three spatial axes which are orthogonal to each other. In the present embodiment, the X axis is an axis that is orthogonal to a central axis SC of the glow plug 10 and extending along the direction penetrating the front-face and back-face of the sheet. A +X axis direction is a direction toward the back-face side of the sheet, and a −X axis direction is a direction toward the front-face side of the sheet. The Y axis is an axis that is orthogonal to the central axis SC of the glow plug 10 and extending along the left-right direction of the sheet. A +Y axis direction is a direction toward the left side of the sheet, and a −Y axis direction is a direction toward the right side of the sheet. The Z axis is an axis that extends along the central axis SC of the glow plug 10. A +Z axis direction is a direction toward the rear side, and a −Z axis direction is a direction toward the front side. The XYZ axes of FIG. 1 correspond to XYZ axes in the other figures.

The glow plug 10 includes a heater portion 100 which generates heat by being energized, and functions as a heat source which helps ignition at the starting of an internal combustion engine (not shown) exemplified by a diesel engine or the like. The glow plug 10 further includes a pressure sensor 360 which detects the pressure acting on the heater portion 100. The glow plug 10 is configured to be able to detect the pressure in the combustion chamber of the internal combustion engine (not shown).

The glow plug 10 includes a shell 210, a ring 260, a center wire 280, an elastic member 310, a sleeve 320, a diaphragm 340, a support member 380, a front cap 400, a housing 500, a protection tube 610, a connector member 620, a spring member 630, a feed terminal 640, and an elastic portion 650, in addition to the heater portion 100 and the pressure sensor 360.

The protection tube 610 of the glow plug 10 is a metal body having electrical conductivity. In the present embodiment, the material of the protection tube 610 is stainless steel (for example, SUS410, SUS630, SUS303, or SUS430). The protection tube 610 has a cylindrical shape extending with the central axis SC set at the center thereof. The protection tube 610 is joined to a rear end portion of the housing 500. The feed terminal 640 is retained inside the protection tube 610 via the connector member 620.

The connector member 620 of the glow plug 10 is a member having electrical insulation property. In the present embodiment, the material of the connector member 620 is insulating resin. The connector member 620 has a cylindrical shape. The feed terminal 640 is fixed to the inside of the connector member 620. In the present embodiment, the spring member 630 is accommodated in the connector member 620. As shown in FIG. 3, the connector member 620 includes a wall surface 623 which defines a region for accommodating the spring member 630 from the front side toward the rear side. In the present embodiment, the wall surface 623 defines a region of a columnar shape from the front side to the rear side of the spring member 630. In the present embodiment, the wall surface 623 defines the entire region extending from the front side to the rear side of the spring member 630. In another embodiment, the wall surface 623 may define at least a part of the region for accommodating the spring member 630.

The spring member 630 of the glow plug 10 is a metal body having electrical conductivity. In the present embodiment, the spring member 630 is phosphor bronze (for example, C5210). The spring member 630 elastically deforms such that the heater portion 100 and the center wire 280 are movable along the axial direction (the Z axis direction) relative to the feed terminal 640. Thus, the spring member 630 absorbs displacement of the center wire 280 which is caused in association with displacement of the heater portion 100. In the present embodiment, the spring member 630 is a curved plate spring. The spring member 630 connects the center wire 280 and the feed terminal 640 such that the center wire 280 and the feed terminal 640 are electrically conductive with each other. In the present embodiment, the spring member 630 includes a welded portion 632 and a welded portion 638 as shown in FIG. 3. The welded portion 632 of the spring member 630 is positioned on the front side of the spring member 630, and is a part that is welded to the rear side of the center wire 280. The welded portion 638 of the spring member 630 is positioned on the rear side of the spring member 630, and is a part that is welded to the front side of the feed terminal 640.

The feed terminal 640 of the glow plug 10 is a metal body having electrical conductivity. In the present embodiment, the material of the feed terminal 640 is brass (for example, C3604BD). The feed terminal 640 is positioned on the rear side relative to the center wire 280. The feed terminal 640 is supplied with electric power for the heater portion 100, from outside the glow plug 10. Electric power inputted to the feed terminal 640 is supplied to a terminal portion 148 of the heater portion 100, via the spring member 630, the center wire 280, and the ring 260.

The elastic portion 650 of the glow plug 10 is a member which covers, while being in contact with the wall surface 623, at least a part of the spring member 630. In the present embodiment, the elastic portion 650 is a member which covers the entire region of the spring member 630, from a position on the front side relative to the welded portion 632 to the rear side of the welded portion 638. In the present embodiment, the elastic portion 650 is filled in the entire region between the spring member 630 and the wall surface 623.

The elastic portion 650 has electrical insulation property and also has elasticity lower than that of the spring member 630. The modulus of elasticity of the elastic portion 650 is lower than the modulus of elasticity of the spring member 630. In the present embodiment, the elastic portion 650 is a paste silicone rubber having viscosity that does not cause fluidization thereof during use of the glow plug 10. In another embodiment, the elastic portion 650 may be a liquid silicone rubber having viscosity that does not cause fluidization thereof during use of the glow plug 10. In another embodiment, the elastic portion 650 may be a silicone gel having viscosity that does not cause fluidization thereof during use of the glow plug 10.

The heater portion 100 of the glow plug 10 is a heat generating element having a rod shape extending from the front side toward the rear side in the Z axis direction (axial direction). In the present embodiment, the heater portion 100 is a ceramic heater formed from a ceramic composition. The heater portion 100 includes a base body 120 and a resistance heating element 140.

The base body 120 of the heater portion 100 is insulating ceramics formed from an insulating ceramic material having electrical insulation property. In the present embodiment, the main component of the base body 120 is silicon nitride (Si₃N₄). The base body 120 holds the resistance heating element 140 therein. The base body 120 electrically insulates the resistance heating element 140 from the outside of the glow plug 10, and transmits heat of the resistance heating element 140 to the outside of the glow plug 10.

The resistance heating element 140 of the heater portion 100 is formed from a conductive material. In the present embodiment, the main component of the resistance heating element 140 is a mixture of tungsten carbide (WC) and silicon nitride (Si₃N₄). The resistance heating element 140 is embedded in the base body 120. The resistance heating element 140 generates heat by being energized. The resistance heating element 140 has a linear shape in which the resistance heating element 140 is folded at the front side.

The resistance heating element 140 includes a folded portion 141, a linear portion 142, a linear portion 144, a terminal portion 146, and the terminal portion 148. The folded portion 141 of the resistance heating element 140 is positioned at the front side of the resistance heating element 140 and has a linear shape in which the folded portion 141 is folded in an arc shape. The folded portion 141 connects the linear portion 142 and the linear portion 144. The linear portion 142 of the resistance heating element 140 has a linear shape extending from the +Y axis direction side of the folded portion 141 toward the rear side. The linear portion 144 of the resistance heating element 140 has a linear shape extending from the −Y axis direction side of the folded portion 141 toward the rear side. The terminal portion 146 of the resistance heating element 140 projects from the linear portion 142, and is exposed on the surface of the base body 120. The terminal portion 148 of the resistance heating element 140 projects from the linear portion 144, and is exposed on the surface of the base body 120.

The shell 210 of the glow plug 10 is a metal body having electrical conductivity. In the present embodiment, the material of the shell 210 is stainless steel (for example, SUS410, SUS630, SUS303, or SUS430). The shell 210 has a cylindrical shape extending with the central axis SC set at the center thereof. The shell 210 has the heater portion 100 press-fitted therein, with the heater portion 100 projecting to the front side and to the rear side. The shell 210 is disposed in a range extending from a position on the front side relative to the terminal portion 146 in the heater portion 100 to a position between the terminal portion 146 and the terminal portion 148. Accordingly, the shell 210 forms a conduction path for the terminal portion 146.

The ring 260 of the glow plug 10 is a metal body having electrical conductivity. In the present embodiment, the material of the ring 260 is stainless steel (for example, SUS410, SUS630, SUS303, or SUS430). The ring 260 has a cylindrical shape extending with the central axis SC set at the center thereof. The rear side of the heater portion 100 is press-fitted in the front side of the ring 260. The front side of the center wire 280 is press-fitted in the rear side of the ring 260. The ring 260 is disposed so as to extend from the terminal portion 148 of the heater portion 100 to the center wire 280. Accordingly, the ring 260 forms a conduction path for the terminal portion 148. The ring 260 mechanically connects the heater portion 100 and the center wire 280, and electrically connects the terminal portion 148 of the heater portion 100 and the center wire 280.

The center wire 280 of the glow plug 10 is a metal body having electrical conductivity. In the present embodiment, the material of the center wire 280 is stainless steel (for example, SUS430, SUS410, SUS630, or SUS303). The center wire 280 extends from the heater portion 100 toward the rear side, and is connected to the heater portion 100 so as to be electrically conductive therewith. In the present embodiment, the center wire 280 has a columnar shape extending with the central axis SC set at the center thereof, and is connected to the heater portion 100 via the ring 260. The center wire 280 relays electric power supplied to the feed terminal 640 from outside the glow plug 10, to the terminal portion 148 of the heater portion 100.

The elastic member 310 of the glow plug 10 has a tubular metal body shaped from a thin metal plate. In the present embodiment, the material of the elastic member 310 is stainless steel (for example, SUS316). In another embodiment, the material of the elastic member 310 may be nickel alloy (for example, INCONEL 718, INCONEL 600, or INCOLOY 909 (“INCONEL” and “INCOLOY” are registered trademarks)). The elastic member 310 is joined to the shell 210 on the front side relative to the sleeve 320, and connects the shell 210 and the housing 500. In the present embodiment, the elastic member 310 is joined to the housing 500 via the support member 380. The elastic member 310 elastically deforms such that the heater portion 100 can be displaced in the axial direction along the central axis SC.

The sleeve 320 of the glow plug 10 is a metal body having electrical conductivity. In the present embodiment, the material of the sleeve 320 is stainless steel (for example, SUS410, SUS630, SUS303, or SUS430). The sleeve 320 has a cylindrical shape extending with the central axis SC set at the center thereof. The sleeve 320 is joined to the shell 210, and extends toward the rear side relative to the heater portion 100. The sleeve 320 transmits displacement of the heater portion 100 to the diaphragm 340.

The sleeve 320 includes a joined portion 322 and a tubular portion 324. The joined portion 322 of the sleeve 320 is a part joined to the shell 210. In the present embodiment, the joined portion 322 is joined to the shell 210 through welding. In another embodiment, the joined portion 322 may be joined to the shell 210 through press-in. The tubular portion 324 of the sleeve 320 has an inner diameter greater than the outer diameter of the shell 210, and is a part surrounding the shell 210. In the present embodiment, the tubular portion 324 forms a gap between the shell 210 and itself over its entire region facing the shell 210. The rear side of the sleeve 320 is joined to the diaphragm 340.

The diaphragm 340 of the glow plug 10 is a metal body having electrical conductivity. In the present embodiment, the material of the diaphragm 340 is stainless steel (for example, SUS410, SUS630, SUS303, or SUS430). The diaphragm 340 has an annular shape about the central axis SC. The sleeve 320 is joined to the inner periphery side of the diaphragm 340. The support member 380 is joined to the outer periphery side of the diaphragm 340. The diaphragm 340 deforms in accordance with displacement of the heater portion 100 which is transmitted via the sleeve 320.

The pressure sensor 360 of the glow plug 10 is joined to the diaphragm 340, and converts the displacement of the heater portion 100 transmitted to the diaphragm 340 via the sleeve 320, into an electric signal. The electric signal generated by the pressure sensor 360 represents the pressure acting on the heater portion 100, that is, the pressure in the combustion chamber of the internal combustion engine (not shown). In the present embodiment, the pressure sensor 360 is a piezoresistive element.

The support member 380 of the glow plug 10 is a metal body having electrical conductivity. In the present embodiment, the material of the support member 380 is stainless steel (for example, SUS410, SUS630, SUS303, or SUS430). The support member 380 has a cylindrical shape extending with the central axis SC set at the center thereof. The rear side of the support member 380 is joined to the diaphragm 340. A front end portion 382 of the support member 380 serves as a part on the front side of the support member 380, and is joined to the housing 500. In the present embodiment, the front end portion 382 is joined to the housing 500 through welding. In the present embodiment, the front end portion 382 is joined to the housing 500 and is also joined to the elastic member 310 and the front cap 400.

The front cap 400 of the glow plug 10 is a tubular metal body having electrical conductivity. In the present embodiment, the material of the front cap 400 is stainless steel (for example, SUS410, SUS630, SUS303, or SUS430). The front cap 400 is joined to a front end portion of the housing 500 via the front end portion 382 of the support member 380. The front cap 400 accommodates the elastic member 310.

The housing 500 of the glow plug 10 is a metal body having electrical conductivity. In the present embodiment, the material of the housing 500 is carbon steel. In another embodiment, the material of the housing 500 may be stainless steel (for example, SUS303). The housing 500 accommodates a part of the heater portion 100, at least a part of the shell 210, and at least a part of the sleeve 320, with the heater portion 100 projecting to the front side.

The housing 500 includes an axial bore 510, a tool engagement portion 520, and a screw portion 540. The axial bore 510 is a through hole extending with the central axis SC set at the center thereof. Inside the axial bore 510, the center wire 280 is positioned on the central axis SC. The tool engagement portion 520 is configured to be engageable with a tool (not shown) which is used at mounting/dismounting of the glow plug 10 to/from the internal combustion engine (not shown). The glow plug 10 is configured to be able to be fixed to the internal combustion engine (not shown), by the screw portion 540 being screwed into a female screw formed in the internal combustion engine (not shown). The tool engagement portion 520 may be provided not in the housing 500 but on the rear side of the protection tube 610.

According to the first embodiment described above, the elastic portion 650 has elasticity lower than that of the spring member 630. Thus, while allowing displacement of the center wire 280 in the axial direction (the Z axis direction) by means of the spring member 630 without hindering the displacement, it is possible to suppress displacement of the center wire 280 in a radial direction (the X axis direction and the Y axis direction) that is orthogonal to the axial direction, by means of the elastic portion 650 via the spring member 630. Therefore, it is possible to prevent measurement errors of the pressure detected based on displacement of the heater portion 100.

The elastic portion 650 is filled between the welded portion 632 of the spring member 630 and the wall surface 623. Accordingly, displacement of the center wire 280 in the radial direction orthogonal to the axial direction can be directly suppressed by means of the elastic portion 650. Therefore, the displacement of the center wire 280 into the radial direction orthogonal to the axial direction can be further suppressed.

In addition, since the elastic portion 650 is in a paste form, the elastic portion 650 which suppresses displacement of the center wire 280 in a radial direction can be easily realized.

### B. Second Embodiment

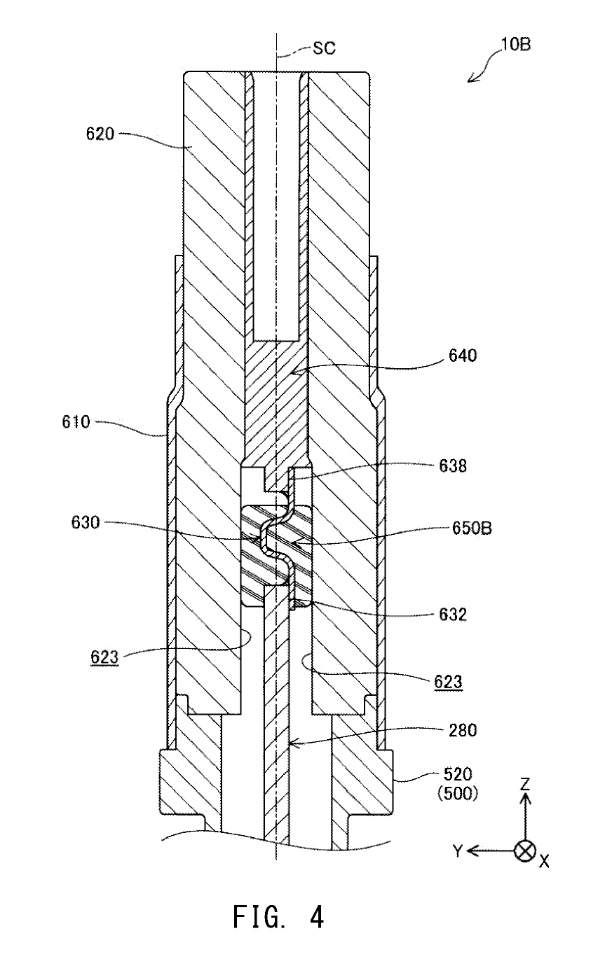

FIG. 4 is an enlarged cross-sectional view of a part of the rear side of a glow plug 10B according to the second embodiment. The glow plug 10B of the second embodiment is the same as the glow plug 10 of the first embodiment except that the glow plug 10B includes an elastic portion 650B instead of the elastic portion 650. The elastic portion 650B of the second embodiment is the same as the elastic portion 650 of the first embodiment except that the elastic portion 650B covers a part of the spring member 630 from the welded portion 632 to a position on the front side relative to the welded portion 638. According to the second embodiment, as in the first embodiment, displacement of the center wire 280 in a radial direction orthogonal to the axial direction can be suppressed by means of the elastic portion 650B. Therefore, measurement errors of the pressure detected based on displacement of the heater portion 100 can be prevented.

### C. Third Embodiment

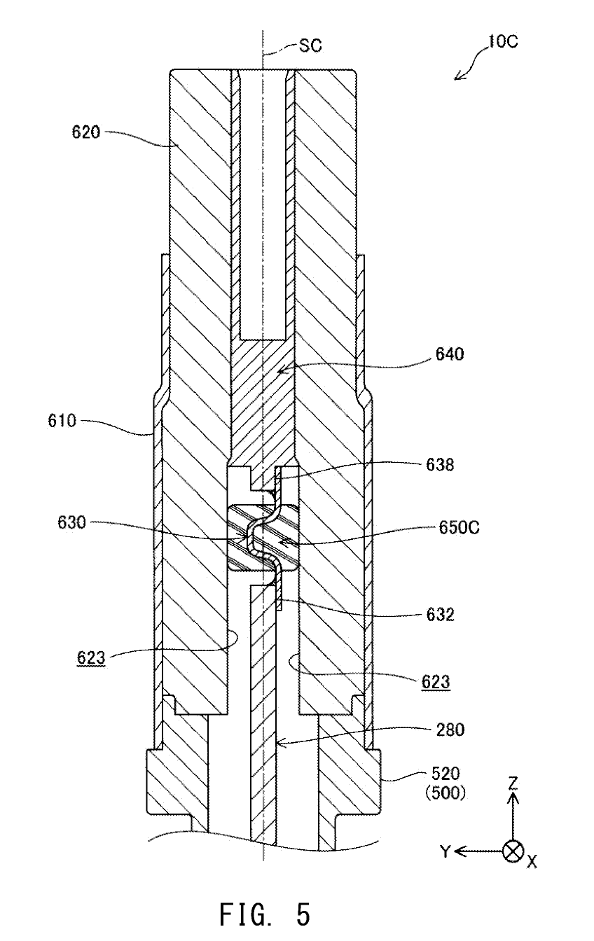

FIG. 5 is an enlarged cross-sectional view of a part of the rear side of a glow plug 10C according to a third embodiment. The glow plug 10C of the third embodiment is the same as the glow plug 10 of the first embodiment except that the glow plug 10C includes an elastic portion 650C instead of the elastic portion 650. The elastic portion 650C of the third embodiment is the same as the elastic portion 650 of the first embodiment except that the elastic portion 650C covers a part of the spring member 630 from a position on the rear side relative to the welded portion 632 to a position on the front side relative to the welded portion 638. According to the third embodiment, as in the first embodiment, displacement of the center wire 280 in a radial direction orthogonal to the axial direction can be suppressed by means of the elastic portion 650C via the spring member 630. Therefore, measurement errors of the pressure detected based on displacement of the heater portion 100 can be prevented.

### D. Other Embodiments

The present invention is not limited to the above embodiments, modes, and modified embodiments, and may be embodied in various other forms without departing from the scope of the invention. For example, the technical features in the embodiments, modes, and modified embodiments corresponding to the technical features in the modes described in Summary of the Invention can be exchanged or combined as appropriate in order to solve a part or the whole of the above-described problem or in order to achieve a part of the whole of the above-described effects. In addition, unless a technical feature is described as essential to the invention in the specification, such a technical feature can be omitted as appropriate.

The heater portion 100 is not limited to a ceramic heater formed from a ceramic composition, and may be a sheath heater having a heating element provided in a sheath tube.

The spring member 630 is not limited to the curved plate spring, and may be a coil spring. The material of the spring member 630 is not limited to phosphor bronze, and may be another material such as stainless steel (for example, SUS304) or nickel (Ni). The material of the feed terminal 640 is not limited to brass, and may be another material such as stainless steel (for example, SUS410, SUS630, SUS303, or SUS430) or free-machining steel (for example, SUM24L).

The wall surface which defines the region for accommodating the spring member 630 is not limited to the wall surface 623 of the connector member 620, and may be a wall surface formed in another member.

The elastic portion 650 may be a solid having rubber elasticity (for example, silicone resin, modified silicone resin, or fluororesin).

### DESCRIPTION OF REFERENCE NUMERALS

10, 10B, 10C: glow plug
100: heater portion
120: base body
140: resistance heating element
141: folded portion
142, 144: linear portion
146, 148: terminal portion
210: shell
260: ring
280: center wire
310: elastic member
320: sleeve
322: joined portion
324: tubular portion
340: diaphragm
360: pressure sensor
380: support member
382: front end portion
400: front cap
500: housing
510: axial bore
520: tool engagement portion
540: screw portion
610: protection tube
620: connector member
623: wall surface
630: spring member
632, 638: welded portion
640: feed terminal
650, 650B, 650C: elastic portion
SC: central axis

Having described the invention, the following is claimed:

1. A glow plug comprising:
a heater portion having a rod shape extending from a front side toward a rear side in an axial direction, the heater portion configured to generate heat by being energized;
a center wire having electrical conductivity, extending from the heater portion toward the rear side, and being connected to the heater portion so as to be electrically conductive therewith;
a feed terminal having electrical conductivity, being positioned on the rear side relative to the center wire, and configured to be supplied with electric power for the heater portion;
a spring member having electrical conductivity and configured to elastically deform such that the heater portion and the center wire are movable along the axial direction relative to the feed terminal, the spring member connecting the center wire and the feed terminal such that the center wire and the feed terminal are electrically conductive with each other;
a wall surface defining a region for accommodating the spring member from the front side toward the rear side; and
an elastic portion having electrical insulation property and lower elasticity than that of the spring member, the elastic portion covering at least a part of the spring member while being in contact with the wall surface.

2. The glow plug according to claim 1, wherein
the spring member includes a welded portion welded to the center wire, and
the elastic portion is filled between the wall surface and at least the welded portion of the spring member.

3. The glow plug according to claim 1 or 2, wherein
the elastic portion is in a paste form.

4. The glow plug according to claim 1 or 2, wherein
the elastic portion is a solid having rubber elasticity.
